(19) United States
(12) Patent Application Publication
(10) Pub. No.: US 2007/0036503 A1
(43) Pub. Date: Feb. 15, 2007

(54) Fiber optic adapter modules with identification system

(76) Inventors: James J. Solheid, Lakeville, MN (US); Trevor Smith, Eden Prairie, MN (US)

Correspondence Address: MERCHANT & GOULD PC, P.O. BOX 2903, MINNEAPOLIS, MN, 55402-0903, US

(21) Appl. No.: 11/202,415

(22) Filed: Aug. 10, 2005

(51) Int. Cl. G02B 6/00

(52) U.S. Cl. 385/134

(57) ABSTRACT

A telecommunications device is disclosed. The telecommunications device includes a fixture and a plurality of adapter modules mounted on the fixture. The plurality of modules form adjacently stacked rows of adapter modules with each one of the modules including a plurality of adapters for connecting fiber optic connectors. Each row of adapter modules is labeled with a different color for ease of customer identification.

### FIELD

This invention pertains to the telecommunications industry. More particularly, this invention pertains to high density fiber distribution devices used in the telecommunications industry and connection identification system that can be used in high density devices.

### BACKGROUND

Fiber optic connectivity and service is being extended to more and more customers, both commercial and residential. With the increase in use of fiber optic cables in the telecommunications industry, it is desirable to provide fiber distribution frames with increased density. By density, it is meant the number of locations per unit volume or unit area for providing connection on the fiber distribution frame.

An example of a high density fiber density distribution frame is shown in commonly-assigned U.S. Pat. No. 5,497,444 issued Mar. 5, 1996. The '444 patent shows a plurality of modules (for example, module 58 in FIG. 18 of the '444 patent) which contain an array of adapters 90 for receiving fiber optic connectors. In the example shown in FIG. 18 of the '444 patent, each module contains six adapters and the entire module can be moved in a direction parallel to the linear array of adapters to permit access to individual connectors carried on the adapters 90. Other high-density devices are illustrated in commonly-owned U.S. Pat. Nos. 5,717,810; 5,758,003; and 6,591,051.

With the increased density of fiber optic connections in telecommunications devices, quick identification/correlation of the individual signals to the corresponding customer equipment, e.g., for service or for other purposes, presents a challenge. A system for quick and simple identification of the source of the individual fiber connections is desired, especially for use in high density environments.

### SUMMARY

The present invention relates to high density fiber optic distribution devices that utilize an identification system for the fiber connections.

According to one inventive aspect, a telecommunications device includes a fixture and a plurality of modules mounted on the fixture wherein the plurality of modules form adjacently positioned arrangements or groups of adapter modules. Each one of the modules includes a plurality of adapters for connecting fiber optic connectors, each arrangement of adapter modules being labeled with a different color for identification.

According to another inventive aspect, a method for identifying fiber optic connections in a fiber optic signal distribution device of the type having a plurality of arrangements or groups of adapter modules is disclosed. The method includes labeling each arrangement of adapter modules with a different module color; designating each adapter in the adapter modules with a different adapter identifier, such as a number; providing an identification label that includes labeling spaces wherein each labeling space is designated with a color corresponding to the module colors and wherein each labeling space is for the designated with a number or other identifier corresponding to the numbers or other identifiers of the adapters in the adapter modules; and labeling the labeling spaces with the information that corresponds to the connections at each of the adapters.

### BRIEF DESCRIPTION OF THE DRAWINGS

The accompanying drawings, which are incorporated in and constitute a part of the specification, illustrate several aspects of the present invention and together with the description, serve to explain the principles of the invention. A brief description of the drawings is as follows:

FIG. 1 is a front perspective view of a telecommunications cabinet according to the present invention, shown with the front doors removed;

FIG. 2 is a front view of the cabinet shown in FIG. 1 including two slidable adapter modules in the extended positions;

FIG. 3 is a perspective view of interior components of the cabinet of FIGS. 1-2;

FIG. 4 is a side view of a slidable adapter module used with the telecommunications cabinet of FIGS. 1-3;

FIG. 5 is an exploded view of the slidable adapter module of FIG. 4, showing the pivoting handle exploded off the housing of the adapter module, the adapter module shown with the clip and the adapters removed from the housing;

FIG. 6 is an identification chart for use with the telecommunications cabinet of FIGS. 1-3, the identification chart used with the identification system of the present invention;

FIG. 7 is a perspective view of another embodiment of a telecommunications cabinet according to the present invention, the telecommunications cabinet including thirty six rows of adapter modules mounted on the cabinet, each adapter module marked in accordance with the identification system of the present invention; and

FIG. 8 is an enlarged side view of a portion of the telecommunications cabinet of FIG. 7.

### DETAILED DESCRIPTION

Reference will now be made in detail to the exemplary aspects of the present invention that are illustrated in the accompanying drawings. Wherever possible, the same reference numbers will be used throughout the drawings to refer to the same or like parts.

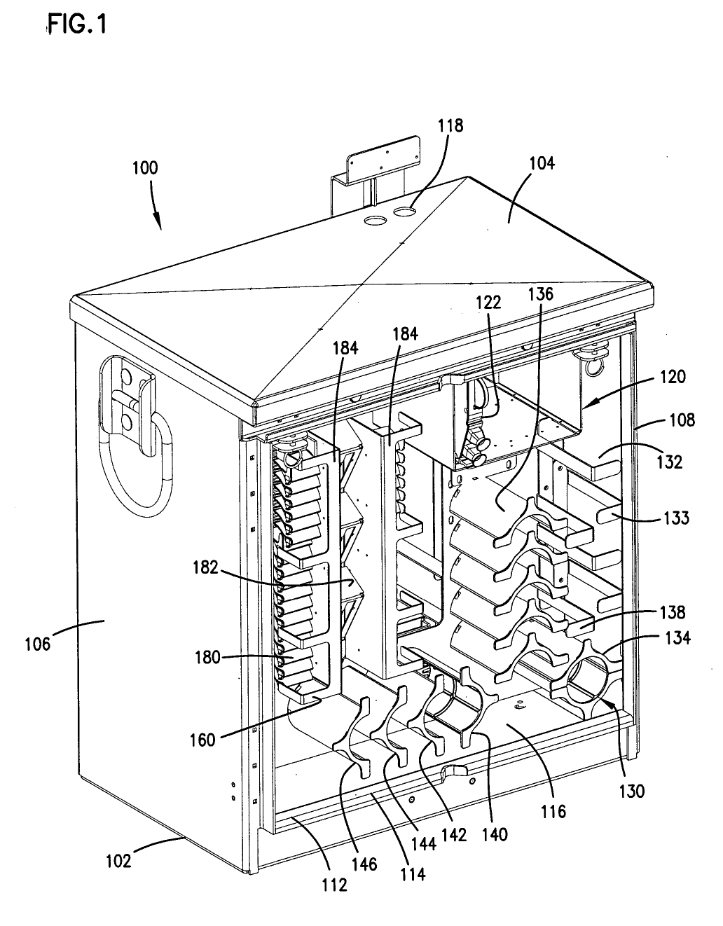

FIGS. 1-3 show a telecommunications connection cabinet 100 such as might be mounted on a pedestal or other mount in an area where fiber optic connectivity is desired. Cabinet 100 provides a location for outside plant fiber optic cables to be connected to fiber optic distribution cables. The distribution cables are then led to equipment to provide fiber optic service and connectivity. One arrangement for providing service might include utilizing a splitter to divide the signal from an outside plant (OSP) cable into a plurality of distribution cables, each distribution cable providing a connection to a particular piece of equipment. A splitter might separate the optic signal within the OSP cable into thirty-two individual signals and also combine those thirty-two signals into the OSP cable in a bi-directional communication configuration. Cabinet 100 can be used to connect an OSP cable to customers' premises. Cabinet 100 is similar to cabinets disclosed in commonly-owned U.S. patent application Ser. No. 11/095,033, filed on Mar. 31, 2005, entitled “ADAPTER BLOCK INCLUDING CONNECTOR STORAGE,” the disclosure of which is incorporated herein by reference.

Still referring to FIGS. 1-3, cabinet 100 includes a base 102, a top 104 and opposing sides 106, 108. A rear wall 110 is disposed opposite a front 112. Front 112 defines an opening 114 into an interior 116 defined by base 102, top 104, sides 106, 108, and rear wall 110. Cables can enter cabinet 100 through opening 118 defined on the top 104.

Disposed within interior 116 is a splitter mounting area 120 including one or more splitters 122. Splitters 122 can be constructed in a similar manner as in commonly-owned U.S. patent application Ser. No. 10/980,978, filed Nov. 3, 2004, entitled “FIBER OPTIC MODULE AND SYSTEM INCLUDING REAR CONNECTORS”, the disclosure of which is incorporated herein by reference.

Cabinet 100 further includes a cable management area 130 including a vertical cable guide 132 for cables extending from splitters 122. A lower spool 134 allows cables to extend back upwardly toward vertical spools 136. Vertical spools 136 allow for slack storage. Vertical spools 136 form a vertical column of discrete spools selectable by the technician for storing slack. Vertical cable guide 132 includes a plurality of fingers 133 for managing the cables. Similarly, additional fingers 138 manage the cables extending to vertical spools 136. A further cable spool 140 manages cables extending from vertical spools 136 toward horizontal spools 142, 144, 146. Horizontal spools 142, 144, 146 manage cables extending upwardly toward a fixture 160. Horizontal spools 142, 144, 146 are arranged in a row.

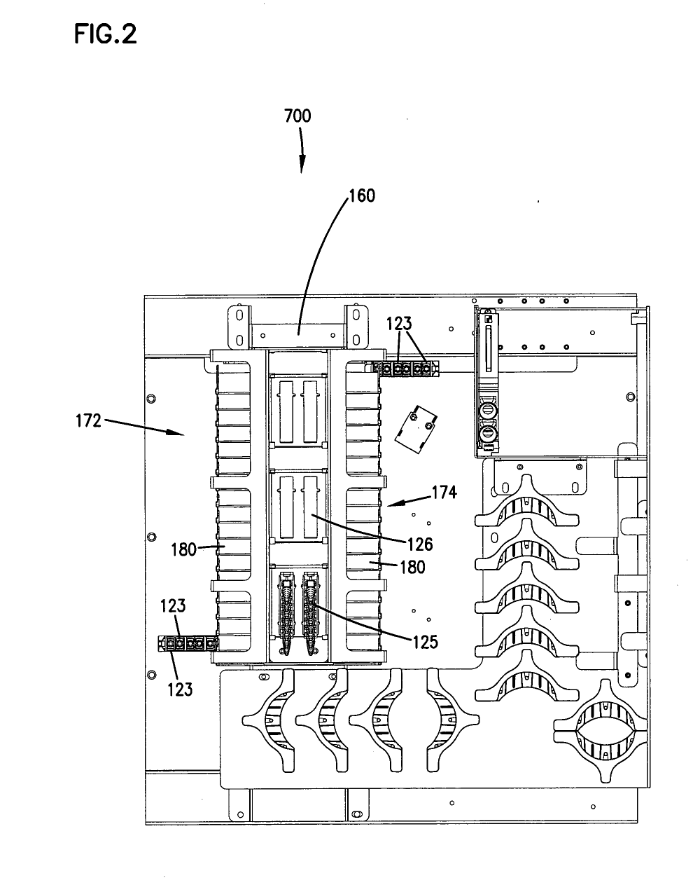

Referring to FIG. 2, fixture 160 includes a plurality of adapters 123 for connecting front fiber optic connectors to rear fiber optic connectors. Cables extend from splitters 122 to front connectors, and cables extend to the customers' premises from the rear connectors to link the splitters 122 to the customers' premises (cables not shown for ease of illustration). Adapters 123 form an adapter array.

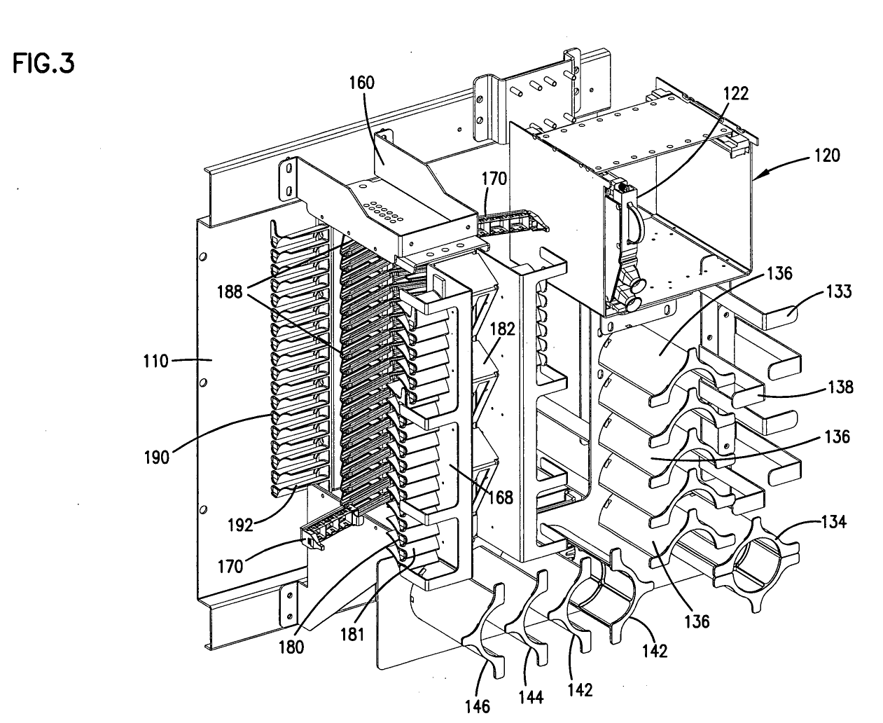

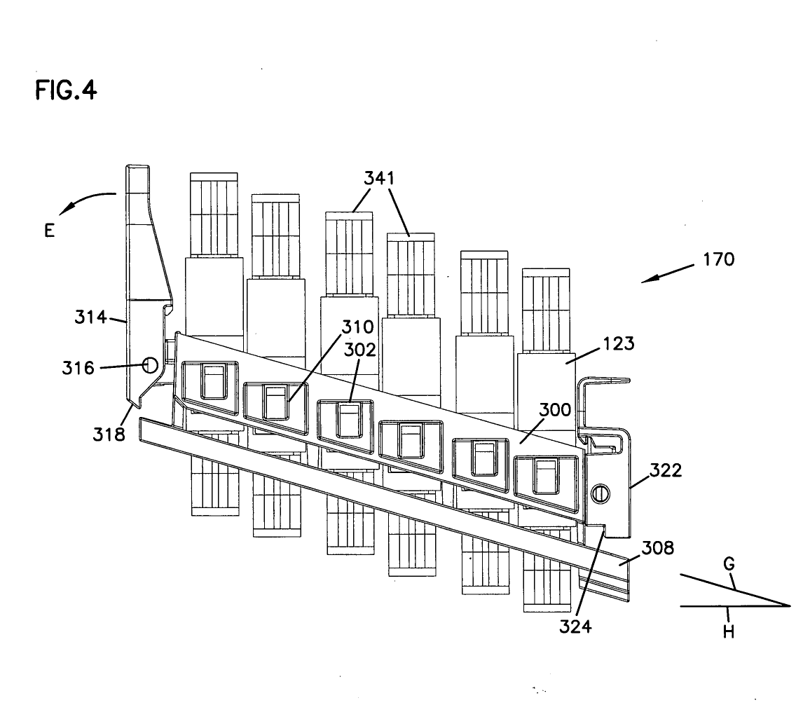

Adapters 123 are mounted on movable adapter modules 170 (See FIGS. 3-4) which are slidable between a retracted position and an extended position (shown in the figures) along guides or walls 188. The adapters have been removed in FIG. 3. Modules 170 include lines of adapters 123 which move along lines of travel parallel to the lines of adapters. In the embodiment shown in FIGS. 1-3, two sets 172, 174 of adapter modules (see FIG. 2) are provided, one set movable horizontally to the left, and the other movable horizontally to the right. By moving a selected module 170 to the extended position along the line of travel, access to individual adapters 123 and connectors is simplified, with less disruption to surrounding connectors and cables. Sliding adapter modules and intermating guides/walls are described in greater detail in commonly-owned U.S. Pat. Nos. 5,497,444; 5,717,810; 5,758,003; and 6,591,051, the disclosures of which are incorporated herein by reference.

In the illustrated embodiment of FIGS. 1-3, only a few adapter modules 170 are shown. In preferred use, there is an adapter module 170 between each adjacent wall 188. As discussed in further detail in U.S. Pat. No. 6,591,051, walls 188 define longitudinal guides which cooperate with guides on modules 170 to provide the linear movement.

The telecommunications cabinet 100 includes front fingers or fanning guides 180 that are positioned adjacent a front 168 of fixture 160 for managing the front cables extending toward adapter modules 170. Two sets of fanning guides 180 are provided, one for each set 172, 174 of adapter modules 170. In the illustrated embodiment of fixture 160, vertical cable guides 184 are also positioned adjacent to both of front fanning guides 180. Front fanning guides 180 include curved surfaces 181 for cable bend radius protection for cables directed downward. Rear cables from modules 170 are managed by rear fingers or fanning guides 190 which include curved surfaces 192 (see FIG. 3) to provide cable bend radius protection for cables directed downward.

Fixture 160 also includes a parking lot or bulkhead 182 for storing connectors until needed for connection to the front of one of adapters 123. Such connection may not initially be needed, but may be desired at a later time. Bulkhead 182 includes openings 126 for receiving connector holders 125 or adapters. In the illustrated embodiment, bulkhead 182 is positioned between cable guides 184 on front 168 of fixture 160. Bulkhead 182 includes segments that are angled downwardly. Such angling assists with cable management so that the cables do not bend 90 degrees or require cable supports to prevent excessive cable bending.

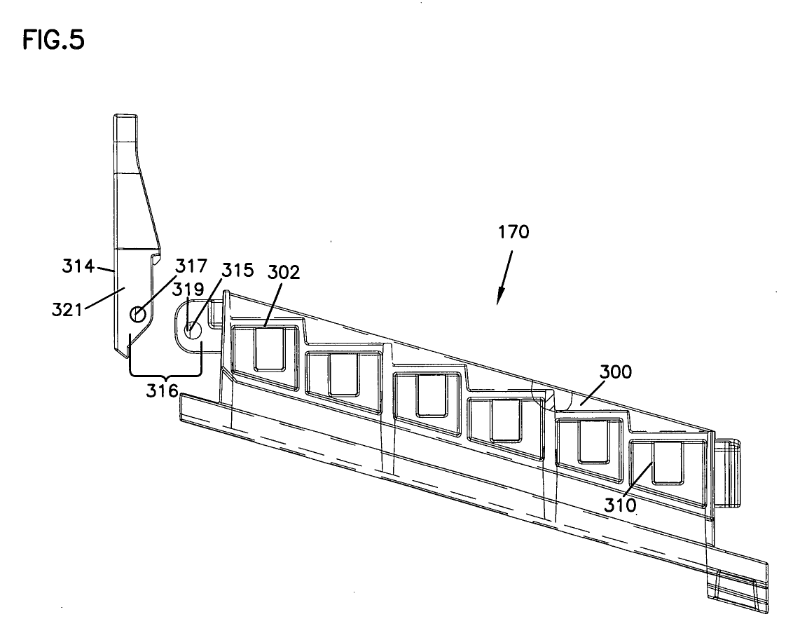

Referring now to FIGS. 4 and 5, one of the slidable adapter modules 170 of the telecommunications cabinet 100 is shown. Adapter module 170 includes a module housing 300 with cooperating guides 308 formed as rails for slideably mating with the grooves of opposed walls 188. Housing 300 includes openings 302 for receiving adapters 123. In the example shown, three openings 302 receive six adapters 123. The adapters 123 snap into side openings 310. The adapters shown are SC type adapters. The adapters 123 are shown with dust caps 341 mounted thereon in FIG. 4. SC type adapters and the corresponding mating connectors are shown for example in U.S. Pat. No. 5,317,663, the disclosure of which is incorporated herein by reference.

Module 170 includes a pivoting handle 314. The pivoting handle 314 pivots about hinge 316 in the direction of arrow E in FIG. 4. The pivoting handle 314 is shown exploded off the module housing 300 in FIG. 5. The hinge 316 is formed by a pair of pins 315 integrally formed on the housing 300 that cooperate with a pair of holes 317 defined on the pivoting handle 314. Only one pin 315 and one hole 317 is shown in FIG. 5. The second pin 315 and the second hole 317 are on opposite sides of module housing 300 and handle 314, and are not visible. The pivoting handle 314 elastically deforms to form a snap-fit connection with pins 315 of housing 300. The pin 315 defines a ramp 319. The ramp 319 facilitates the coupling of the pivoting handle 314 to the housing 300 by causing sidewalls 321 with holes 317 of the pivoting handle 314 to flex out.

The tip 318 of the pivoting handle 314 engages with wall 188 to lift adapter module housing 300 so as to allow movement from the retracted position to the extended position. A corner 324 of a slide handle or clip 322 engages the wall 188 to retain module 170 in the retracted position. Slide handle 322 is spring loaded to resist movement. The details of the operation of the sliding adapter modules 170 and the intermating structures between the modules 170 and the walls 188 are described in further detail in U.S. Pat. No. 6,591,051.

As shown in FIG. 4, axis G defines the line of travel and presents the adapters 123 in a staggered arrangement relative to transverse direction H. Such relative positioning helps reduce cable pull as module 170 is moved linearly along axis G. Modules 170 can be angled as shown, or they can be perpendicularly moved relative to the fixture.

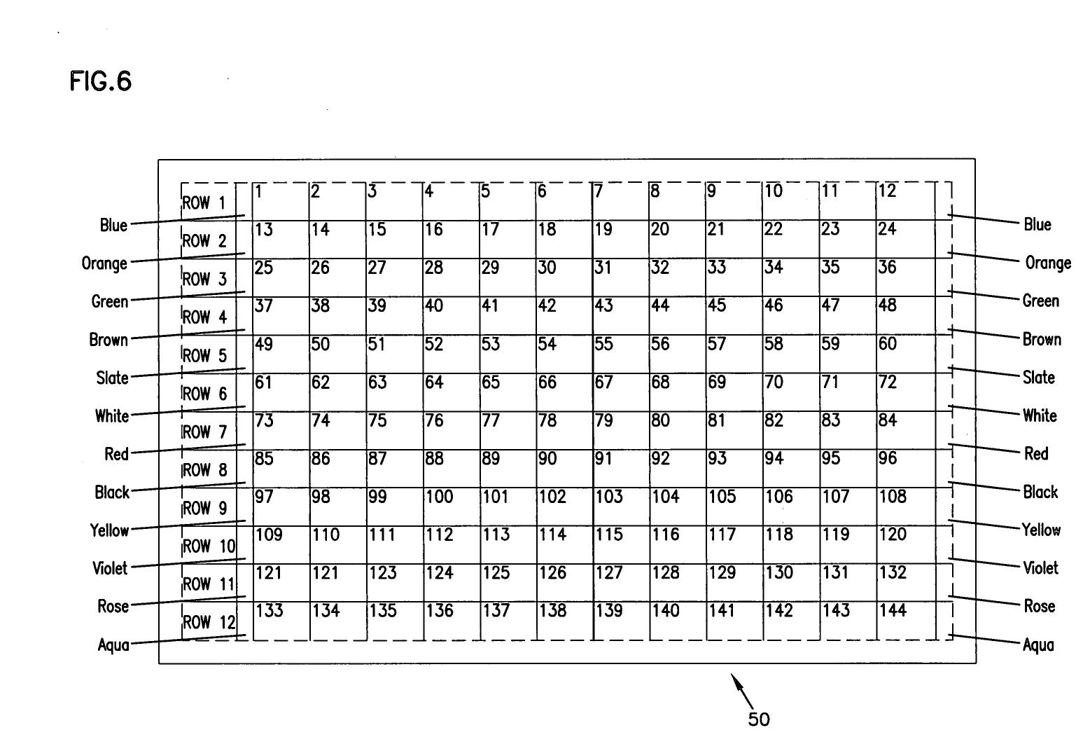

Since devices such as the above-discussed telecommunications cabinet 100 and other cabinets, fixtures, and racks can have a high density of connections, an identification system where the connections corresponding to each customer equipment can be more easily identified by the field technician is desirable. FIG. 6 illustrates an identification chart 50 to be used with an identification system according to the present invention. Chart 50 can be located within cabinet 100, such as on the inside of one of the doors.

In accordance with the identification system of the present invention, the adapter modules 170 are color coded where each group (for example each row) of the adapter modules 170 is designated by a differentiating color. In the example described herein, up to twelve different colors are used. Moreover, within each row of modules 170, each connection/adapter is individually designated by an identifier, such as a number, the numbering illustrated in the chart 50 in FIG. 6.

As seen in the identification chart 50 in FIG. 6, the numbers increase going from the adapter module 172 (see FIG. 2) on the left side of the fixture 160 toward the adapter module 174 (see FIG. 2) on the right side of the fixture 160.

Regarding color-coding, a portion of each of the adapter modules 170 is marked with a different color as mentioned before. In the preferred embodiment, the pivoting handles 314 of the modules 170 are marked with the designated colors. The pivoting handles 314 are visible at the outer ends of the modules 170. As shown in the chart in FIG. 5, the colors used for marking consist of blue, orange, green, brown, slate, white, red, black, yellow, violet, rose, and aqua. These colors are used for twelve rows of modules and then repeated for every twelve rows thereafter if the distribution cabinet includes more than twelve vertically stacked rows of modules. These twelve colors are conveniently used by operators because they are colors that are recognizable in the telecommunications industry. For example, 12 fiber cables will use these colors on the cable jackets to distinguish the 12 fibers in each cable.

The pivoting handle 314 is a preferred portion of the module 170 for color coding. Since the pivoting handle 314 is a snap-fit part, it can be marked or molded with the appropriate color and coupled to the module 170 after assembly of the module 170. Also, different color arrangements can easily be created by merely changing colors and/or increasing or decreasing the number of colors.

In marking the chart 50, each customer's information can be recorded in the appropriate boxes or spaces (labeled #1-144 in the chart in FIG. 6). For example, if a customer whose information has been entered into to box #131, requests service or a change in service, the rose colored pivoting handle is easily identified and the second adapter from the right (of module 174) is accessed, since that adapter corresponds to number #131. As another example, customer #40 needs service, so the operator locates the green colored handle on the left side, and counts over four adapters from the left.

According to one aspect of the invention, the pivoting handles 314 of the modules 170 may be labeled with a certain color or may be physically molded with the designated color. In other embodiments, other parts of the modules 170 may be labeled with the designated colors instead of the pivoting handles 314. As mentioned before, the chart illustrated in FIG. 6 may be provided in a location in close proximity to the distribution cabinet such as on the inside of the cabinet so that field technicians can have quick access to the chart 50 during service. This color-coding system, thus, makes it possible to identify the desired customer connections by matching the corresponding colors and adapter identifiers (e.g., numbers) in the chart 50 with the colors of the pivoting handles 314 and the adapters of the modules 170.

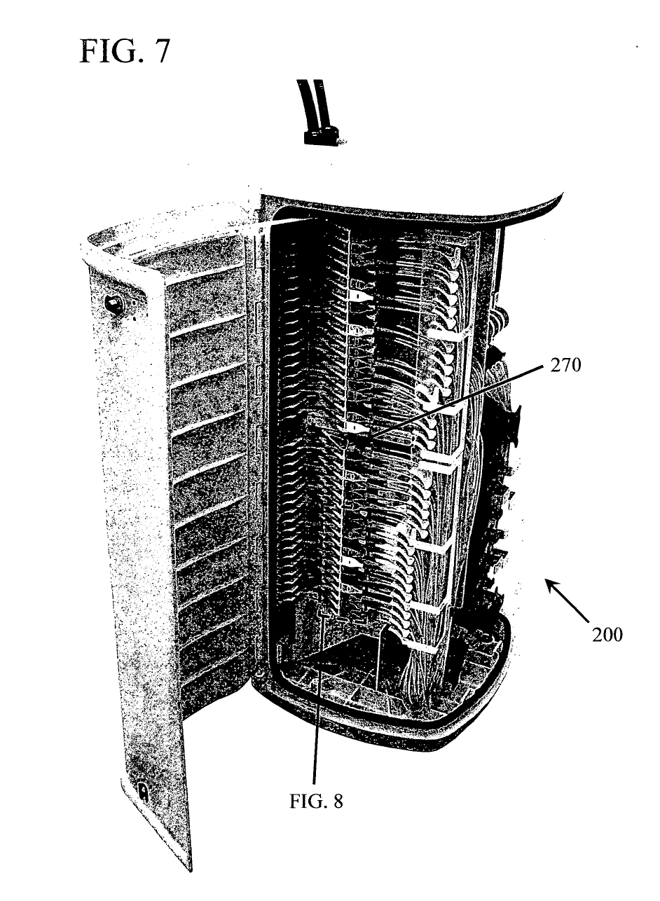

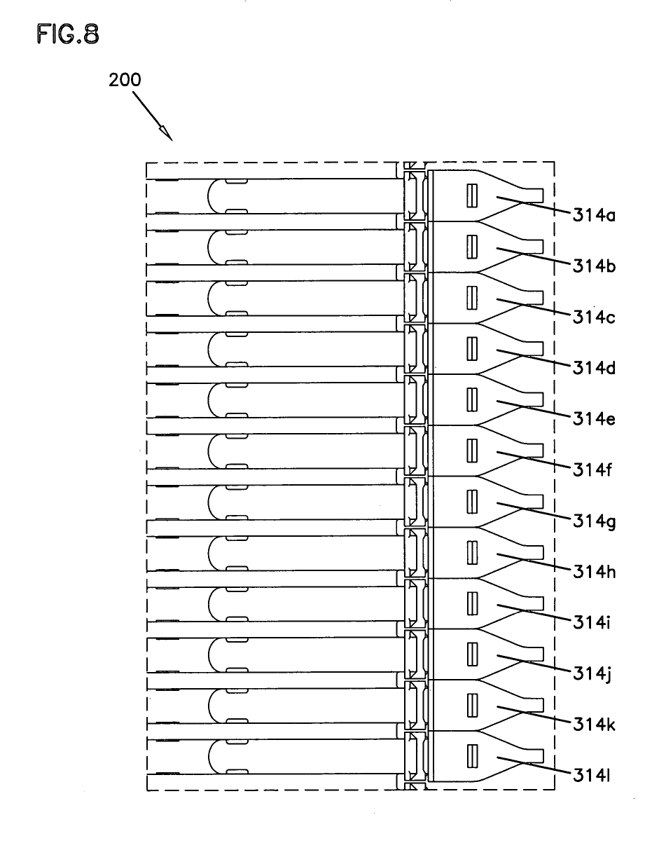

In FIGS. 7 and 8, another embodiment of a telecommunications cabinet 200 according to the present invention is shown. Telecommunications cabinet 200 is similar to the cabinet 100 of FIGS. 1-3, except that cabinet 200 is larger, including thirty-six rows of adapter modules 270 mounted on the cabinet. It should also be noted that modules 270 are similar to modules 170 of FIGS. 1-5, except that modules 270 do not have staggered adapters 123 and do not slide at an angle relative to the transverse direction.

A close-up side view of a portion of the telecommunications cabinet 200 is illustrated in FIG. 8. In FIG. 8, twelve rows of adapter modules 270 are shown in closer detail, each labeled with a different color. In FIG. 8, the pivoting handle 314a of the first row (in the close-up view) is colored blue, the pivoting handle 314b is colored orange, the pivoting handle 314c is colored green, the pivoting handle 314d is colored brown, the pivoting handle 314e is colored slate, the pivoting handle 314f is colored white, the pivoting handle 314g is colored red, the pivoting handle 314h is colored black, the pivoting handle 314i is colored yellow, the pivoting handle 314j is colored violet, the pivoting handle 314k is colored rose, and the pivoting handle 314l is colored aqua. This color scheme is repeated for each twelve rows of adapter modules thereafter. Since the cabinet 200 in FIGS. 7 and 8 includes thirty-six rows of adapter modules, the twelve colors mentioned above are used three times each.

Furthermore, since each adapter module 270 includes six adapters 123, there will be 432 (6×36×2) different labeling boxes/spaces on the identification chart 50 that is used with the cabinet 200. Each box is labeled with the corresponding customer information using the color and number scheme of the chart 50, each customer connection can be easily identified on the dense array of adapters.

The above specification, examples and data provide a complete description of the manufacture and use of the invention. Since many embodiments of the invention can be made without departing from the spirit and scope of the invention, the invention resides in the claims hereinafter appended.

What is claimed is:

1. A telecommunications device comprising:
a fixture; and
a plurality of modules mounted on said fixture wherein the plurality of modules form adjacently positioned rows of adapter modules mounted on the fixture with each of said modules movably mounted on said fixture for movement along a line of travel, each one of said modules including a plurality of adapters for connecting fiber optic connectors, each one of said adapters movable with said one of said modules along said line of travel, each row of adapter modules being labeled with a different color for identification.

2. A telecommunications device according to claim 1, wherein each row of adapter modules is labeled with a different color selected from the group consisting of blue, orange, green, brown, slate, white, red, black, yellow, violet, rose, and aqua.

3. A telecommunications device according to claim 1, wherein said modules each have a longitudinal axis, each row of adapter modules including two adapter module portions mounted on said fixture in adjacent relation with said longitudinal axes generally parallel to said line of travel, said plurality of adapters of each adapter module portion linearly disposed along said longitudinal axis.

4. A telecommunications device according to claim 1, wherein said fixture includes a plurality of spaced-apart walls, opposing pairs of said walls defining cooperating guides for intermating with each of said modules, said walls for attaching said modules to said walls and accommodating movement of each of said modules along said line of travel.

5. A telecommunications device according to claim 1, wherein the plurality of modules includes at least twelve adjacent rows of adapter modules wherein each row includes two adapter modules that are movable away from each other.

6. A telecommunications device according to claim 5, wherein the at least twelve adjacent rows of adapter modules include at least twenty-four adjacent rows of adapter modules, wherein the different colors repeat at least once.

7. A telecommunications device according to claim 1, wherein each adapter module is configured to accommodate six adapters.

8. A telecommunications device according to claim 1, wherein the adapters are SC type adapters.

9. A telecommunications device according to claim 1, wherein each adapter module includes a pivoting handle to provide for unlocking of the modules relative to the fixture, the pivoting handles being labeled with the different colors.

10. A telecommunications device according to claim 9, wherein the pivoting handles are mounted to the modules with a snap-fit connection.

11. A method for identifying fiber optic connections in a fiber optic signal distribution device of the type having a plurality of adapter modules, the adapter modules forming adjacently positioned rows of modules, wherein each adapter module includes a plurality of fiber optic adapters mounted thereon, the method comprising the steps of:
labeling each row of adapter modules with a different module color;
designating each adapter in the adapter modules with a different adapter identifier;
providing an identification chart that includes corresponding rows of labeling spaces wherein each row of labeling space is designated with a color corresponding to the module colors of the rows of adapter modules and wherein each labeling space is designated by an identifier corresponding to the identifiers of the adapters in the adapter modules;
labeling the labeling spaces with the customer information that corresponds to the connections at each of the adapters.

12. An identification system according to claim 11, wherein each row of adapter modules is labeled with a color chosen from the group of colors consisting of blue, orange, green, brown, slate, white, red, black, yellow, violet, rose, and aqua.

13. An identification system according to claim 11, wherein each adapter module includes a snap-fit portion, wherein the snap-fit portions of the adapter modules are labeled with the different colors, the method comprising the step of snapping the snap-fit portions onto the adapter modules.

14. A telecommunications device comprising:
a fixture; and
a plurality of modules mounted on said fixture wherein the plurality of modules form adjacently positioned rows of adapter modules mounted on the fixture with each one of said modules including a plurality of adapters for connecting fiber optic connectors, each row of adapter modules being labeled with a different color for identification.

15. A telecommunications device according to claim 14, wherein each row of adapter modules is labeled with a different color selected from the group consisting of blue, orange, green, brown, slate, white, red, black, yellow, violet, rose, and aqua.

16. A telecommunications device according to claim 14, wherein the plurality of modules includes at least twelve adjacent rows of adapter modules wherein each row includes two adapter modules.

17. A telecommunications device according to claim 16, wherein the at least twelve adjacent rows of adapter modules include adjacent rows of adapter modules wherein each row includes two adapter modules.

18. A telecommunications device according to claim 14, wherein each adapter module is configured to accommodate six adapters.

19. A telecommunications device according to claim 14, wherein each adapter module includes a snap-fit portion, wherein the snap-fit portions of the adapter modules are labeled with the different colors.

20. A telecommunications device according to claim 19, wherein the portion of the adapter modules that are labeled with the different colors are snap-fit with the adapter modules via a pin/hole arrangement.
